(19) United States
(12) Patent Application Publication
(10) Pub. No.: US 2025/0175442 A1
(43) Pub. Date: May 29, 2025

(54) TRANSMISSION SYSTEM, TRANSMITTING APPARATUS, RECEIVING APPARATUS, AND DATA TRANSMISSION METHOD

(71) Applicant: Sumitomo Electric Industries, Ltd., Osaka-shi, Osaka (JP)

(72) Inventor: Manabu KOTANI, Osaka-shi, Osaka (JP)

(73) Assignee: Sumitomo Electric Industries, Ltd., Osaka-shi, Osaka (JP)

(21) Appl. No.: 18/842,498

(22) PCT Filed: Dec. 6, 2022
(86) PCT No.: PCT/JP2022/044976

§ 371 Date: Aug. 29, 2024

(30) Foreign Application Priority Data
Mar. 2, 2022 (JP) 2022-031854

(51) Int. Cl. H04L 49/9023; H04L 47/30

(52) U.S. Cl. CPC H04L 49/9023; H04L 47/30

(57) ABSTRACT

A transmitting apparatus transmits a management frame and a waiting time information after transmitting a first client data output from a first buffer to a receiving apparatus. A first control unit waits for second client data to be output from the first buffer until the transmitting apparatus completes transmission of the management frame and the waiting time information. A second control unit, based on the waiting time information, determines an output start timing at which output of the second client data from the second buffer. The output start timing is a timing at which a time shorter than a data reception interval elapses from completion of output of the first client data from the second buffer. The reception interval is a time from completion of reception of the first client data by the receiving apparatus to start of reception of the second client data by the receiving apparatus.

### TECHNICAL FIELD

The present disclosure relates to a transmission system, a transmitting apparatus, a receiving apparatus, and a data transmission method. This application claims priority based on Japanese Patent Application No. 2022-031854 filed on Mar. 2, 2022, and the entire contents of the Japanese patent application are incorporated herein by reference.

### BACKGROUND ART

A transmission system that transmits a client signal transmitted from a client device is known. For example, in the transmission system that transmits an Ethernet frame (“Ethernet” is a registered trademark), an OAM frame (OAM: Operations, Administration, Maintenance) for management is transmitted/received between transmission apparatuses. The transmission apparatus inserts the OAM frame between the Ethernet frames transmitted from the client device, and transmits the OAM frame to the opposite transmission apparatus. The transmission apparatus which has received the OAM frame transmits the Ethernet frame except the OAM frame to the client device. A delay occurs in the Ethernet frame subsequent to the OAM frame, and a blank period (gap) corresponding to the OAM frame exists between the Ethernet frames before and after the OAM frame. As described above, the insertion of the OAM frame causes a jitter of the frame.

Patent literature 1 discloses a transmission apparatus that measures blank time between packets input to the transmission apparatus, compares a data length of an OAM frame with the blank time, and inserts the OAM frame into the blank time when there is the blank time into which the OAM frame is inserted.

### CITATION LIST

### Patent Literature

Patent literature 1: Japanese Unexamined Patent Application Publication No. 2013-062595

### SUMMARY OF INVENTION

A transmission system according to an embodiment of present disclosure includes a transmitting apparatus configured to receive client data transmitted from a first client device and transmit the received client data, and a receiving apparatus configured to receive the client data transmitted from the transmitting apparatus and transmit the received client data to a second client device. The transmitting apparatus includes a first buffer configured to store the client data transmitted from the first client device and a first control unit configured to control a timing of outputting the client data from the first buffer to transmit the client data to the receiving apparatus. The receiving apparatus includes a second buffer configured to store the client data transmitted from the transmitting apparatus and a second control unit configured to control a timing of outputting the client data from the second buffer to transmit the client data to the second client device. The transmitting apparatus is configured to, after transmitting first client data output from the first buffer to the receiving apparatus, transmit a management frame and waiting time information, the management frame being used for management of the transmission system. The first control unit is configured to wait for second client data to be output from the first buffer until the transmitting apparatus completes transmission of the management frame and the waiting time information, and cause the first buffer to output the second client data after the transmitting apparatus completes the transmission of the management frame and the waiting time information. The waiting time information is information based on a waiting time, the waiting time being a time of waiting for the second client data to be output from the first buffer. The second control unit is configured to determine an output start timing at which output of the second client data from the second buffer starts, based on the waiting time information, and cause the second buffer to start the output of the second client data at the determined output start timing. The output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus.

The present disclosure can be realized not only as a transmission system, a transmitting apparatus, and a receiving apparatus having the characteristic configurations as described above, and a data transmission method having steps of characteristic processing in the transmission system, but also as a computer program that causes a computer to function as the transmitting apparatus, and as a computer program that causes the computer to function as the receiving apparatus. The present disclosure can be realized by implementing a part or all of the transmitting apparatus as a semiconductor integrated circuit, or by implementing a part or all of the receiving apparatus as the semiconductor integrated circuit.

### BRIEF DESCRIPTION OF THE DRAWINGS

FIG. 1 is a diagram illustrating an example of a configuration of a transmission system according to an embodiment.

FIG. 2 is a block diagram illustrating an example of a configuration of a transmission apparatus according to the embodiment.

FIG. 3 is a diagram for explaining a transmission path of a frame in a transmission system according to the embodiment.

FIG. 4 is a timing chart for explaining an example of input/output timing of a frame in a conventional transmission system.

FIG. 5A is a flowchart illustrating the first half of an example of processing of a control unit in a transmission apparatus functioning as a transmitting apparatus according to the embodiment.

FIG. 5B is a flowchart illustrating the second half of an example of processing of the control unit in the transmission apparatus functioning as the transmitting apparatus according to the embodiment.

FIG. 6 is a timing chart for explaining an example of input/output timing of a frame in a transmission system according to the embodiment.

FIG. 7 is a flowchart illustrating an example of OAM frame processing of a control unit in a transmission apparatus functioning as a receiving apparatus according to the embodiment.

FIG. 8 is a flowchart illustrating an example of buffer control processing of a control unit in a transmission apparatus functioning as a receiving apparatus according to the embodiment.

FIG. 9A is a flowchart illustrating the first half of an example of processing of a control unit in a transmission apparatus functioning as a transmitting apparatus according to a first modification.

FIG. 9B is a flowchart illustrating the second half of an example of processing of the control unit in the transmission apparatus functioning as the transmitting apparatus according to the first modification.

FIG. 10 is a timing chart for explaining an input/output timing of a frame in the first modification of the transmission system according to the embodiment.

FIG. 11 is a flowchart illustrating an example of OAM frame processing of the control unit in the transmission apparatus functioning as a receiving apparatus according to the first modification.

FIG. 12 is a diagram illustrating a relationship between a frame boundary and a clock cycle in a second modification of the transmission apparatus according to the embodiment.

### DETAILED DESCRIPTION

### Problems to be Solved by the Present Disclosure

However, in the transmission apparatus disclosed in Patent Literature 1, when there is no blank time for inserting an OAM frame, the OAM frame may be forcibly inserted between packets. The transmission apparatus received the OAM frame transmits a frame preceding the OAM frame, and then transmits the subsequent frame after a gap is provided by removing the OAM frame. In this case, a jitter is inevitably generated.

### Effects of Present Disclosure

According to the present disclosure, a jitter caused by an insertion of a management frame between client data can be reduced.

### Outline of Embodiments of Present Disclosure

The following is an outline of embodiments of the present disclosure.
(1) A transmission system according to an embodiment of present disclosure includes a transmitting apparatus configured to receive client data transmitted from a first client device and transmit the received client data, and a receiving apparatus configured to receive the client data transmitted from the transmitting apparatus and transmit the received client data to a second client device. The transmitting apparatus includes a first buffer configured to store the client data transmitted from the first client device and a first control unit configured to control a timing of outputting the client data from the first buffer to transmit the client data to the receiving apparatus. The receiving apparatus includes a second buffer configured to store the client data transmitted from the transmitting apparatus and a second control unit configured to control a timing of outputting the client data from the second buffer to transmit the client data to the second client device. The transmitting apparatus is configured to, after transmitting first client data output from the first buffer to the receiving apparatus, transmit a management frame and waiting time information, the management frame being used for management of the transmission system. The first control unit is configured to wait for second client data to be output from the first buffer until the transmitting apparatus completes transmission of the management frame and the waiting time information, and cause the first buffer to output the second client data after the transmitting apparatus completes the transmission of the management frame and the waiting time information. The waiting time information is information based on a waiting time, the waiting time being a time of waiting for the second client data to be output from the first buffer. The second control unit is configured to determine an output start timing at which output of the second client data from the second buffer starts, based on the waiting time information, and cause the second buffer to start the output of the second client data at the determined output start timing. The output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus. Thus, the interval between the first client data and the second client data transmitted from the receiving apparatus is shorter than the interval between the first client data and the second client data received by the receiving apparatus, and the jitter can be reduced.
(2) In (1), the output start timing may be a timing at which a time obtained by subtracting the waiting time from the data reception interval elapses from completion of output of the first client data from the second buffer. Thus, the interval between the first client data and the second client data transmitted from the receiving apparatus can be matched with the interval between the first client data and the second client data received by the transmitting apparatus, and the jitter can be prevented.
(3) In (1) or (2), the first control unit may be configured to calculate, as the waiting time, a sum of a time from start of input of the second client data to the first buffer to completion of the transmission of the management frame and the waiting time information and a preset time interval between frames. Thus, the waiting time can be accurately calculated.
(4) In any one of (1) to (3), the waiting time information may be stored in a specific area of the management frame. Thus, the waiting time information can be transmitted from the transmitting apparatus without generating a frame for the waiting time information.
(5) In (4), the management frame may be an OAM frame, and the waiting time information may be stored in a Local/Remote Information TLV of the OAM frame. Thus, the waiting time information can be stored in the OAM frame.
(6) In any one of (1) to (3), the waiting time information may be stored in a notification frame, the notification frame being a frame different from the management frame. Thus, the waiting time information can be transmitted from the transmitting apparatus by the notification frame different from the management frame.
(7) In any one of (1) to (6), the client data may be a frame. Thus, the jitter can be reduced in a system that transmits data in units of frames.
(8) In any one of (1) to (6), the client data may be a frame group including a plurality of frames. Thus, the jitter can be reduced in a system that transmits data in units of frame groups.
(9) A transmitting apparatus according to the embodiment of the present disclosure is a transmitting apparatus for receiving client data transmitted from a client device and transmitting the received client data to a receiving apparatus. The transmitting apparatus includes a buffer configured to store the client data transmitted from the client device, and a control unit configured to control a timing of outputting the client data from the buffer to transmit the client data to the receiving apparatus. The transmitting apparatus is configured to, after transmitting first client data output from the buffer to the receiving apparatus, transmit a management frame and waiting time information, the management frame being used for management of a transmission system including the transmitting apparatus and the receiving apparatus. The control unit is configured to wait for second client data to be output from the buffer until the transmitting apparatus completes transmission of the management frame and the waiting time information, and cause the buffer to output the second client data after the transmitting apparatus completes the transmission of the management frame and the waiting time information. The waiting time information is information based on a waiting time, the waiting time being a time of waiting for the second client data to be output from the buffer. Thus, the transmitting apparatus can notify the receiving apparatus of the waiting time information necessary for the receiving apparatus to reduce the jitter. The receiving apparatus can make the interval between the first client data and the second client data transmitted from the receiving apparatus shorter than the interval between the first client data and the second client data received in the receiving apparatus using the waiting time information, and can reduce the jitter.
(10) A receiving apparatus according to the embodiment of the present disclosure is a receiving apparatus for receiving client data transmitted from a transmitting apparatus and transmitting the received client data to a client device. the receiving apparatus includes a second buffer configured to store the client data transmitted from the transmitting apparatus and a control unit configured to control a timing of outputting the client data from the second buffer to transmit the client data to the client device. The receiving apparatus is configured to, after receiving first client data transmitted from the transmitting apparatus, receive a management frame and waiting time information transmitted from the transmitting apparatus, the management frame being used for management of a transmission system including the transmitting apparatus and the receiving apparatus, and further receive second client data transmitted from the transmitting apparatus after receiving the management frame and the waiting time information. The waiting time information is information based on a waiting time, the waiting time being a time of waiting for the second client data to be output from a first buffer included in the transmitting apparatus to transmit the management frame and the waiting time information from the transmitting apparatus. The control unit is configured to determine an output start timing at which output of the second client data from the second buffer starts, based on the waiting time information, and cause the second buffer to start the output of the second client data at the determined output start timing. The output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus. Thus, the interval between the first client data and the second client data transmitted from the receiving apparatus is shorter than the interval between the first client data and the second client data received by the receiving apparatus, and the jitter can be reduced.
(11) A data transmission method according to the embodiment of the present disclosure is a data transmission method in a transmission system including a transmitting apparatus and a receiving apparatus. the data transmission method includes, by the transmitting apparatus, inputting first client data received from a first client device to a first buffer, and after transmitting the first client data output from the first buffer to the receiving apparatus, transmitting a management frame and waiting time information, the management frame being used for management of the transmission system; by the transmitting apparatus, waiting for second client data to be output from the first buffer until the transmitting apparatus completes transmission of the management frame and the waiting time information, causing the first buffer to output the second client data after the transmitting apparatus completes the transmission of the management frame and the waiting time information, and transmitting the second client data output from the first buffer to the receiving apparatus; by the receiving apparatus, receiving the management frame, the waiting time information, and the second client data transmitted from the transmitting apparatus, and inputting the received second client data to a second buffer; and by the receiving apparatus, determining an output start timing at which output of the second client data from the second buffer starts, based on the waiting time information, causing the second buffer to start the output of the second client data at the determined output start timing, and transmitting the second client data output from the second buffer to a second client device. The waiting time information is information based on a waiting time, the waiting time being a time of waiting for the second client data to be output from the first buffer. The output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus. Thus, the interval between the first client data and the second client data transmitted from the receiving apparatus is shorter than the interval between the first client data and the second client data received by the receiving apparatus, and the jitter can be reduced.

### Details of Embodiments of Present Disclosure

Hereinafter, embodiments of the present invention will be described in detail with reference to the drawings. At least a part of the embodiments described below may be arbitrarily combined.

### 1. Transmission System

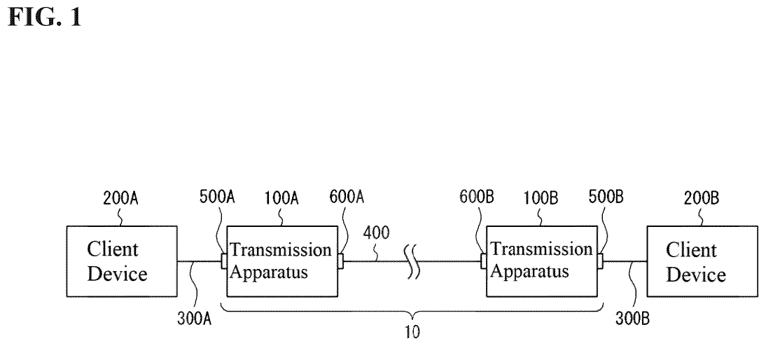

FIG. 1 is a diagram illustrating an example of a configuration of a transmission system according to an embodiment. A transmission system 10 includes transmission apparatuses 100A and 100B. Transmission apparatuses 100A and 100B are optical transmission apparatuses, and transmit optical signals between transmission apparatuses 100A and 100B.

Transmission apparatus 100A is connected to a client device 200A through an optical fiber cable 300A. Client device 200A includes an Ethernet interface (“Ethernet” is a registered trademark) and can transmit/receive Ethernet frames. An optical transceiver 500A is connected to transmission apparatus 100A, and one end of optical fiber cable 300A is connected to optical transceiver 500A. Transmission apparatus 100A can transmit/receive Ethernet frames to and from client device 200A.

Transmission apparatus 100B is connected to a client device 200B through an optical fiber cable 300B. The connection configuration between transmission apparatus 100B and client device 200B is similar to the connection configuration between transmission apparatus 100A and client device 200A, and thus the description thereof will be omitted. Note that the communication between transmission apparatus 100A and client device 200A and the communication between transmission apparatus 100B and client device 200B don't have to be optical communication. That is, transmission apparatus 100A and client device 200A may be connected by a transmission cable for electric signal, and transmission apparatus 100B and client device 200B may be connected by the transmission cable for the electric signal.

Hereinafter, client devices 200A and 200B transmit/receive the Ethernet frames with data stored in the payload. Hereinafter, the Ethernet frame transmitted/received by client devices 200A and 200B is also referred to as a “data frame”. The data frame is an example of “client data”.

Transmission apparatus 100A is arranged at, for example, a site A where client device 200A is arranged. Transmission apparatus 100B is arranged at a site B which is a remote site of site A. Client device 200B is also arranged at site B.

Transmission apparatuses 100A and 100B are connected to each other through an optical fiber cable 400. An optical transceiver 600A is connected to transmission apparatus 100A, and one end of optical fiber cable 400 is connected to optical transceiver 600A. Similarly, an optical transceiver 600B is connected to transmission apparatus 100B, and the other end of optical fiber cable 400 is connected to optical transceiver 600B.

Transmission apparatus 100A receives the data frame transmitted from client device 200A and transmits the data frame to transmission apparatus 100B. Transmission apparatus 100B receives the data frame transmitted from transmission apparatus 100A and transmits the data frame to client device 200B. Transmission apparatus 100B receives the data frame transmitted from client device 200B and transmits the data frame to transmission apparatus 100A. Transmission apparatus 100A receives the data frame transmitted from transmission apparatus 100B and transmits the data frame to client device 200A.

Transmission apparatuses 100A and 100B can transmit/receive an OAM frame, which is an Ethernet frame for management. The OAM frame is a frame conforming to, for example, Gigabit Ethernet-Passive Optical Network (GE-PON) defined in IEEE 802.3ah. The OAM frame is an example of a “management frame”. As another example, the OAM frame may be a frame conforming to Ethernet OAM defined in IEEE 802.1ag.

### 2. Transmission Apparatus

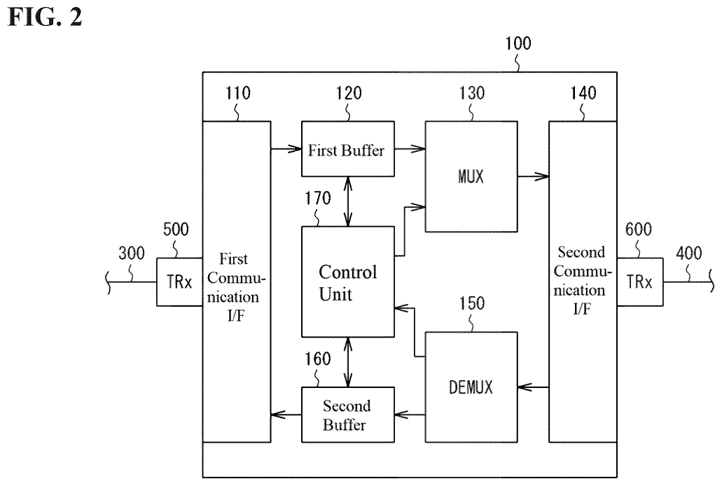

FIG. 2 is a block diagram illustrating an example of the configuration of a transmission apparatus according to the embodiment. In the following description, transmission apparatuses 100A and 100B are also collectively referred to as a “transmission apparatus 100”. Similarly, in the following description, the letters “A” or “B” at the end of the reference numerals other than transmission apparatuses 100A and 100B may be omitted.

As shown in FIG. 2, transmission apparatus 100 according to the embodiment includes a first communication interface (I/F) 110, a first buffer 120, a multiplexer (MUX) 130, a second communication I/F 140, a demultiplexer (DEMUX) 150, a second buffer 160, and a control unit 170.

First communication I/F 110 is an Ethernet interface. First communication I/F 110 includes a connector to which an optical transceiver 500 can be connected, and optical transceiver 500 is connected to first communication I/F 110. First communication I/F 110 may transmit/receive a data frame through optical transceiver 500.

Communication I/F 110 outputs the received data frame to first buffer 120. First buffer 120 stores the data frame output from communication I/F 110. First buffer 120 writes and reads data frames by FIFO (First In, First Out). Specifically, first buffer 120 is a cut-through buffer. That is, first buffer 120 can output a part of the data frame before the input of the entire data frame is completed. First buffer 120 may be a fragment-free buffer.

The data frame output from first buffer 120 is input to multiplexer 130. As described later, the OAM frame output from control unit 170 is also input to multiplexer 130. Multiplexer 130 can aggregate the data frame output from first buffer 120 and the OAM frame output from control unit 170 and output the aggregated data frame and OAM frame from one output port.

Second communication I/F 140 is an Ethernet interface. Second communication I/F 140 includes a connector to which an optical transceiver 600 can be connected, and optical transceiver 600 is connected to second communication I/F 140. Second communication I/F 140 may transmit/receive a data frame through optical transceiver 600.

Second communication I/F 140 accepts the data frame or the OAM frame output from multiplexer 130, and transmits the accepted data frame or OAM frame to transmission apparatus 100, which is the counterpart apparatus, through optical transceiver 600. Second communication I/F 140 receives the data frame or the OAM frame transmitted from transmission apparatus 100, which is the counterpart apparatus, through optical transceiver 600, and outputs the received data frame or OAM frame to demultiplexer 150.

Demultiplexer 150 includes two output ports. One output port is connected to second buffer 160, and the other output port is connected to control unit 170. Demultiplexer 150 allocates the input data frame and OAM frame to two output ports. Specifically, demultiplexer 150 outputs the input data frame from the output port connected to second buffer 160, and outputs the input OAM frame from the output port connected to control unit 170.

Second buffer 160 stores the data frame output from demultiplexer 150. Second buffer 160 writes and reads data frames by FIFO. Specifically, second buffer 160 is a cut-through buffer. Second buffer 160 may be a fragment-free buffer.

The data frame output from second buffer 160 is input to first communication I/F 110. First communication I/F 110 transmits the data frame input from second buffer 160 to a client device 200 through optical transceiver 500.

Control unit 170 controls the timing of outputting the data frame from first buffer 120 in order to transmit the data frame to the corresponding transmission apparatus 100. Control unit 170 controls the timing of outputting the data frame from second buffer 160 in order to transmit the data frame to client device 200. Further, control unit 170 generates the OAM frame used for management of transmission system 10, and outputs the generated OAM frame to multiplexer 130. The OAM frame is an example of a management frame. Control unit 170 accepts the OAM frame output from demultiplexer 150. Control unit 170 can execute processing for management of transmission system 10 in accordance with the accepted OAM frame.

Each of first communication I/F 110, first buffer 120, multiplexer 130, second communication I/F 140, demultiplexer 150, second buffer 160, and control unit 170 is configured by a hardware circuit. For example, each of first communication I/F 110, first buffer 120, multiplexer 130, second communication I/F 140, demultiplexer 150, second buffer 160, and control unit 170 is configured by a semiconductor integrated circuit. Specifically, each of first communication I/F 110, first buffer 120, multiplexer 130, second communication I/F 140, demultiplexer 150, second buffer 160, and control unit 170 may be configured by a programmable logic device such as an application specific integrated circuit (ASIC) or a field programmable gate array (FPGA). In one example, first communication I/F 110, first buffer 120, multiplexer 130, second communication I/F 140, demultiplexer 150, second buffer 160, and control unit 170 may be configured by one FPGA. In another example, control unit 170 may include a processor and a memory. The memory stores a control program for controlling the timing of data output of first buffer 120 and second buffer 160 and for generating and outputting the OAM frame. The processor can perform the timing control of data output of first buffer 120 and second buffer 160 and generation and output of the OAM frame by executing the control program.

### 3. Operation of Transmission System

Transmission apparatus 100 according to the embodiment may function as a transmitting apparatus that transmits the data frame received from client device 200 to the corresponding transmission apparatus 100. Further, transmission apparatus 100 can function as a receiving apparatus that receives the data frame transmitted from the corresponding transmission apparatus 100 and transmits the received data frame to client device 200. When transmission apparatus 100A functions as a transmitting apparatus, transmission apparatus 100B functions as a receiving apparatus. When transmission apparatus 100A functions as a receiving apparatus, transmission apparatus 100B functions as a transmitting apparatus.

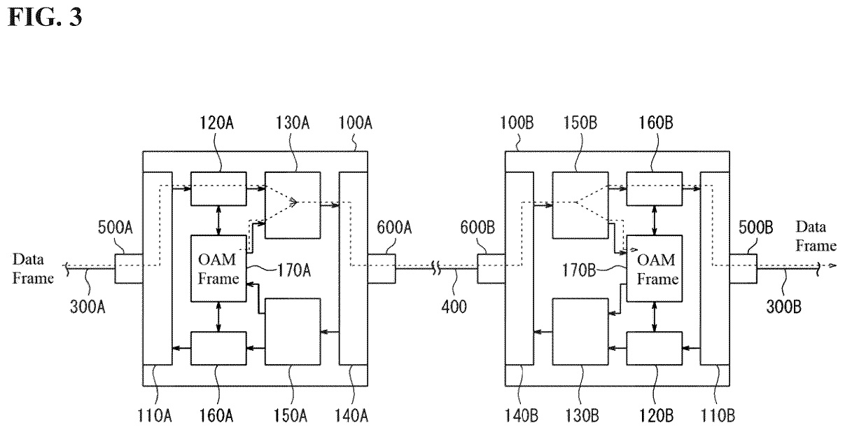

In the following, a case where transmission apparatus 100A functions as a transmitting apparatus and transmission apparatus 100B functions as a receiving apparatus will be described. FIG. 3 is a diagram for explaining a transmission path of a frame in the transmission system according to the embodiment. In the following description, “A” is added to the end of the reference numeral of the constituent element of transmission apparatus 100A, and “B” is added to the end of the reference numeral of the constituent element of transmission apparatus 100B.

The dashed line arrows in the figure indicate the transmission paths of the frames. The data frame transmitted from client device 200 (first client device) is transmitted through optical fiber cable 300A and is received by transmission apparatus 100A through optical transceiver 500A. A first communication I/F 110A of transmission apparatus 100A outputs the received data frame to a first buffer 120A. First buffer 120A temporarily holds the data frame and outputs the data frame to a multiplexer 130A by FIFO. The output timing of the data frame from first buffer 120A to multiplexer 130A is controlled by a control unit 170A. Multiplexer 130A outputs the input data frame to a second communication I/F 140A. Second communication I/F 140A transmits the input data frame to optical fiber cable 400 through optical transceiver 600A.

Control unit 170A outputs the OAM frame to multiplexer 130A. Multiplexer 130A outputs the input OAM frame to second communication I/F 140A. Second communication I/F 140A transmits the input OAM frame to optical fiber cable 400 through optical transceiver 600A.

Control unit 170A controls the output timing of the data frame and the OAM frame from first buffer 120A so as to avoid the conflict between the data frame and the OAM frame. That is, control unit 170A instructs first buffer 120A to output the data frame at the output timing and controls the output timing of the OAM frame so that the output period of the data frame and the output period of the OAM frame do not overlap.

The data frame and the OAM frame transmitted through optical fiber cable 400 are received by transmission apparatus 100B through optical transceiver 500. A second communication I/F 140B of transmission apparatus 100B outputs the received data frame and OAM frame to a demultiplexer 150B. Demultiplexer 150B outputs the input data frame to a second buffer 160B. Second buffer 160B temporarily holds the data frame and outputs the data frame to a first communication I/F 110B by FIFO. The output timing of the data frame from second buffer 160B to first communication I/F 110B is controlled by a control unit 170B. First communication I/F 110B transmits the input data frame to optical fiber cable 300B through an optical transceiver 500B. The data frame transmitted through optical fiber cable 300B is received by client device 200B (second client device).

Demultiplexer 150B outputs the input OAM frame to control unit 170B. Control unit 170B executes processing for management of transmission system 10 in accordance with the input OAM frame. The OAM frame is not input to second buffer 160B, and the data frame is input to second buffer 160B. Control unit 170B instructs second buffer 160B to output the data frame at a timing for shortening the gap between the data frames generated by removing the OAM frame. Then a jitter can be reduced.

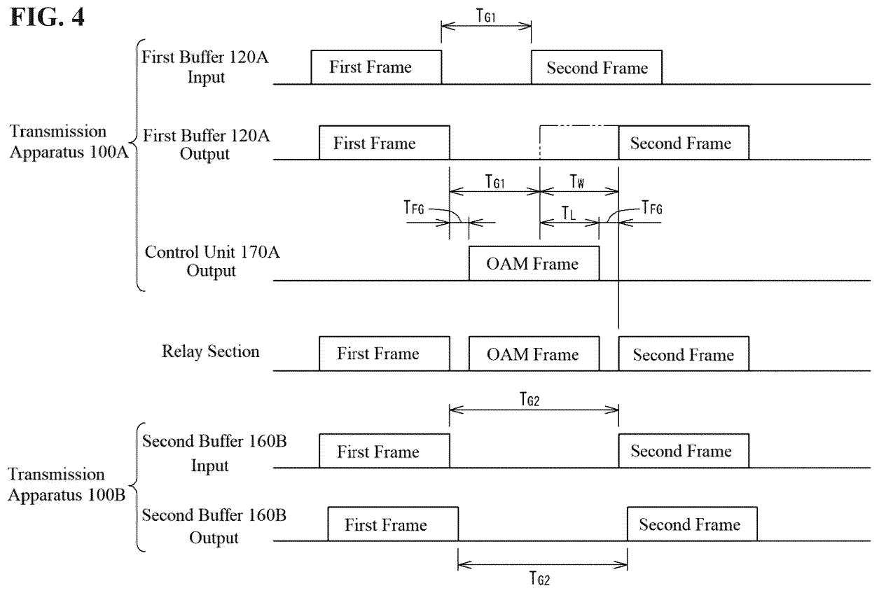

Hereinafter, the output timing control of the data frame of first buffer 120A by control unit 170A and the output timing control of the data frame of second buffer 160B by control unit 170B will be described. First, input/output timing of frames of first buffer 120 and second buffer 160 in a conventional transmission system will be described. FIG. 4 is a timing chart for explaining an example of input/output timing of a frame in the conventional transmission system. In the following description, the data frame transmitted from client device 200A in advance is referred to as a “first frame”, and the data frame transmitted from client device 200A subsequent to the first frame is referred to as a “second frame”.

A gap (blank period) between the first frame and the second frame transmitted from client device 200A is a time T_{G1}. In transmission apparatus 100A, the first frame is input to first buffer 120A, and the first frame is output from first buffer 120A. After time T_{G1} from the timing at which the end of the first frame is input to first buffer 120A, the start of the second frame is input to first buffer 120A.

At a timing when a preset inter-frame gap T_{FG} elapses from the completion of the output of the first frame from first buffer 120A, control unit 170A starts the output of an OAM frame 700. During the output of OAM frame 700, the input of the second frame to first buffer 120A is started. When OAM frame 700 is not output, first buffer 120A starts outputting the second frame after time T_{G1} elapses from the start of outputting the first frame. A period in which the second frame is supposed to be output from first buffer 120A when OAM frame 700 is not output is indicated by a two dot chain line in the figure. The time from the timing at which the output of the second frame from first buffer 120A is supposed to be started without the output of OAM frame 700 (hereinafter referred to as “scheduled output start timing”) to the timing at which the output of OAM frame 700 from control unit 170A is completed is referred to as T_{L}. Control unit 170A waits for the start of the output of the second frame from first buffer 120A until the output of OAM frame 700 from control unit 170A is completed. Control unit 170A causes first buffer 120A to start outputting the second frame after a waiting time T_{W} elapses from the scheduled output timing. Waiting time T_{W} is equal to the sum of a period T_{L} and inter-frame gap T_{FG}. In the case where the input of the second frame to first buffer 120A is started before the transmission of the first frame is completed, when the OAM frame is not inserted, the output of the second frame is started after inter-frame gap T_{FG} elapses from the completion of the output of the first frame from first buffer 120A. In the case where the input of the second frame to first buffer 120A is started before the transmission of the first frame is completed, the OAM frame is inserted in the same manner as described above when inserting the OAM frame. That is, inter-frame gap T_{FG} is provided before and after the OAM frame. Period T_{L} in this case is the maximum and coincides with the transmission period of the entire OAM frame.

In optical fiber cable 400, the first frame, OAM frame 700, and the second frame are transmitted in this order. Inter-frame gap T_{FG} is provided between the first frame and OAM frame 700, and between OAM frame 700 and the second frame. In the following description, the section of optical fiber cable 400 is referred to as a “relay section”.

The first frame is first input to second buffer 160B of transmission apparatus 100B, and the first frame is output from second buffer 160B immediately after the input of the first frame. In the example of FIG. 4, the output of the first frame from second buffer 160B is started before the input of the first frame to second buffer 160B is completed. After a time T_{G2} from the timing at which the end of the first frame is input to second buffer 160B, the start of the second frame is input to second buffer 160B. Further, after time T_{G2} from the timing at which the end of the first frame is output from second buffer 160B, the start of the second frame is output from second buffer 160B.

Time T_{G2} is a period longer than time T_{G1}. Specifically, time T_{G2} is equal to the sum of inter-frame gap T_{FG}, the transmission period of OAM frame 700, and inter-frame gap T_{FG}. Thus, a frame jitter occurs in the conventional transmission system 10.

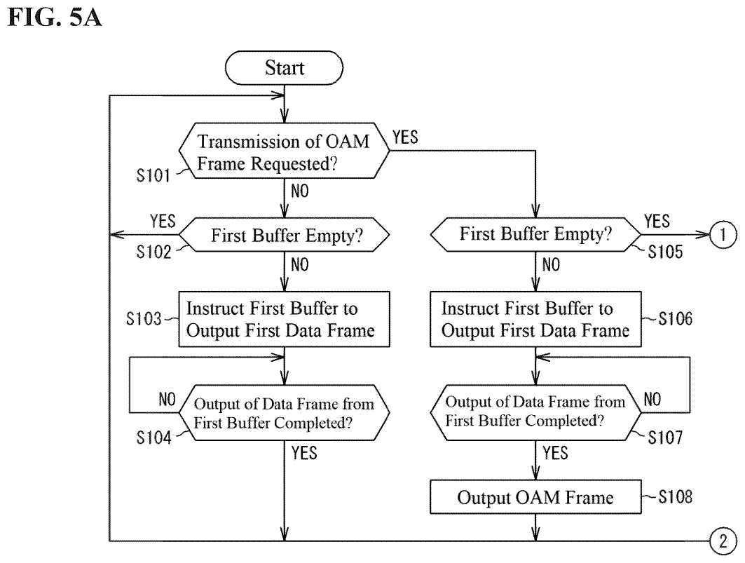

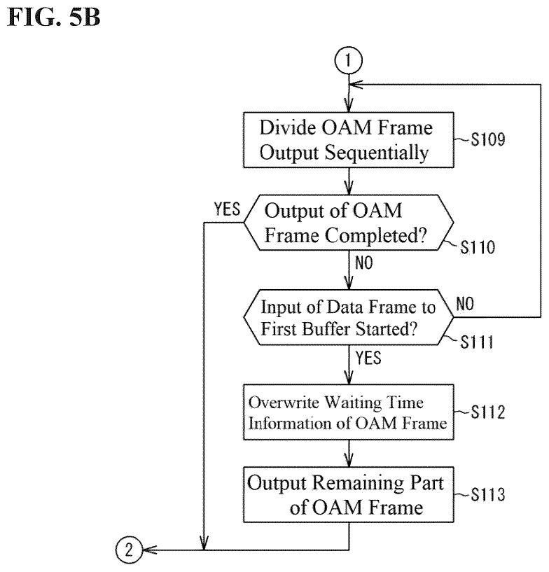

Next, the operation of transmission system 10 according to the embodiment will be described. FIG. 5A and FIG. 5B are flowcharts illustrating an example of processing of control unit 170 in transmission apparatus 100 functioning as the transmitting apparatus according to the embodiment.

Referring to FIG. 5A and FIG. 5B, control unit 170 of transmission apparatus 100 functioning as the transmitting apparatus determines whether or not there is a request-to-send of the OAM frame (step S101). For example, the transmission of the OAM frame is requested at regular intervals.

Control unit 170 can refer to the state of first buffer 120 (a state of holding data or a state of not holding data (empty)). When the transmission of the OAM frame is not requested (NO in step S101), control unit 170 determines whether or not first buffer 120 is empty (step S102). When first buffer 120 is empty (YES in step S102), control unit 170 returns to step S101.

If first buffer 120 is not empty (holding data) (NO in step S102), control unit 170 instructs first buffer 120 to output the held data frame (step S103). Control unit 170 instructs first buffer 120 to output data frames in units of one frame. That is, in step S103, control unit 170 instructs first buffer 120 to output the first data frame (the data frame that is first input to first buffer 120 among the data frames held in first buffer 120).

When the output of the data frame is completed, first buffer 120 notifies control unit 170 of completion of output. Control unit 170 determines whether or not the output of the data frame from first buffer 120 is completed by determining whether or not the notification of the completion of output of the data frame from first buffer 120 is accepted (step S104). When the output of the data frame from first buffer 120 has not been completed (NO in step S104), control unit 170 executes step S104 again. When the output of the data frame from first buffer 120 is completed (YES in step S104), control unit 170 returns to step S101.

When the transmission of the OAM frame is requested (YES in step S101), control unit 170 determines whether or not first buffer 120 is empty (step S105). When first buffer 120 is not empty (NO in step S105), control unit 170 instructs first buffer 120 to output the first data frame (step S106).

Control unit 170 determines whether or not the output of the data frame from first buffer 120 is completed by determining whether or not the notification of the completion of output of the data frame from first buffer 120 is accepted (step S107). When the output of the data frame from first buffer 120 has not been completed (NO in step S107), control unit 170 executes step S107 again.

When the output of the data frame from first buffer 120 is completed (YES in step S107), control unit 170 outputs the OAM frame after inter-frame gap T_{FG} elapses from the timing of the completion of output (step S108). The waiting time information is stored in a specific area of the OAM frame output in step S108. In the embodiment, the waiting time information is information indicating waiting time T_{W}. However, the waiting time information does not have to be information indicating waiting time T_{W} itself, and may be, for example, information indicating a time approximate to waiting time T_{W}. In a specific example, waiting time T_{W} is obtained by adding time T_{L} and inter-frame gap T_{FG}. In this case, time T_{L} is the maximum value. For example, control unit 170 can store in advance the maximum value of waiting time T_{W}, which is the sum of inter-frame gap T_{FG} and the maximum value of time T_{L}, and store the stored maximum value of waiting time T_{W} in the specific area of the OAM frame. The specific area is a Local/Remote Information TLV, and more specifically, is an area of Vendor Specific Information which is the last 4 bytes of the Local/Remote Information TLV. In the specific area of the OAM frame, waiting time information indicating that waiting time T_{W} is zero is set as a default.

When the output of the OAM frame is completed, control unit 170 returns to step S101.

When first buffer 120 is empty in step S105 (YES in step S105), control unit 170 divides the OAM frame into specific sizes and sequentially outputs the divided OAM frames (step S109). Control unit 170 determines whether or not the output of the OAM frame is completed, that is, whether or not the output of the last part of the OAM frame is completed (step S110). When the output of the last part of the OAM frame is completed (YES in step S110), control unit 170 returns to step S101.

When the input of a new data frame starts, first buffer 120 notifies control unit 170 of the start of the input of the data frame. When the output of the OAM frame has not been completed (NO in step S110), control unit 170 determines whether or not the input of the data frame to first buffer 120 is started by determining whether or not a notification of the start of the input of the data frame from first buffer 120 is accepted (step S111). When the input of the data frame to first buffer 120 has not been started (NO in step S111), control unit 170 returns to step S109.

When the input of the data frame to first buffer 120 starts (YES in step S111), control unit 170 calculates waiting time T_{W} and overwrites the waiting time information in the specific area of the OAM frame (step S112). In a specific example, waiting time T_{W} is obtained by adding time T_{L} and inter-frame gap T_{FG}. The calculation of time T_{L} will be described later.

Control unit 170 outputs the remaining part of the OAM frame (step S113), and returns to step S101.

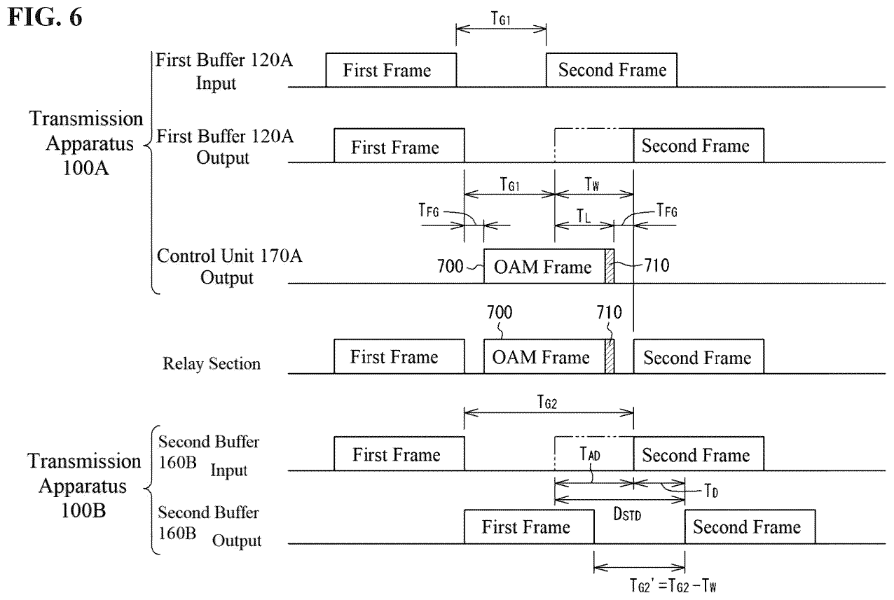

FIG. 6 is a timing chart for explaining an example of input/output timing of the frame in the transmission system according to the embodiment.

An example of transmitting/receiving of the frame in transmission apparatus 100A which is a transmitting apparatus will be described with reference to FIG. 6. Control unit 170A executes the above-described processing, and thereby transmission apparatus 100A operates as follows. First communication I/F 110A of transmission apparatus 100A starts receiving the first frame transmitted from client device 200A and starts inputting the received first frame to first buffer 120A.

Control unit 170A controls first buffer 120A to start outputting the first frame. The output part of the first frame is input to second communication I/F 140A, and second communication I/F 140A starts the transmission of the first frame in the relay section.

The reception of the first frame by first communication I/F 110A is completed, and the input of the first frame to first buffer 120A by first communication I/F 110A is completed.

The output of the first frame from first buffer 120A is completed, and the transmission of the first frame from second communication I/F 140A to transmission apparatus 100B is completed.

At a timing when inter-frame gap T_{FG} elapses from the completion of the output of the first frame from first buffer 120A, control unit 170A starts the output of OAM frame 700. Second communication I/F 140A starts the transmission of OAM frame 700.

In this example, during OAM frame 700 is being output from control unit 170A, first communication I/F 110A starts the reception of the second frame transmitted from client device 200A. First communication I/F 110A starts the input of the second frame to first buffer 120A.

Control unit 170A calculates waiting time T_{W} when the transmission request of OAM frame 700 and the transmission request of the second frame conflict with each other. As described above, waiting time T_{W} is obtained by adding time T_{L} and inter-frame gap T_{FG}. Time T_{L} can be calculated as a time from the input timing of the second frame to first buffer 120A to the completion timing of outputting of OAM frame 700. In a specific example, control unit 170A can calculate an output period required for the output of OAM frame 700 from control unit 170A from the frame length of OAM frame 700 set in advance and the transmission speed in the relay section (the output speed of OAM frame 700 from control unit 170A), and calculate the remaining time of the output period from the input timing of the second frame to first buffer 120A as time T_{L}.

Control unit 170A stores waiting time information 710 in a specific area of OAM frame 700.

Control unit 170A waits for the start of the output of the second frame from first buffer 120A until the output of OAM frame 700 from control unit 170A is completed. Control unit 170A completes the output of OAM frame 700, and second communication I/F 140A completes the transmission of OAM frame 700.

Control unit 170A causes first buffer 120A to start outputting the second frame at a timing after inter-frame gap T_{FG} elapses from the completion of output of OAM frame 700. Second communication I/F 140A starts the transmission of the second frame.

The reception of the second frame by first communication I/F 110A is completed, and the input of the received second frame to first buffer 120A is completed.

The output of the second frame from first buffer 120A is completed, and the transmission of the second frame from second communication I/F 140A to transmission apparatus 100B is completed.

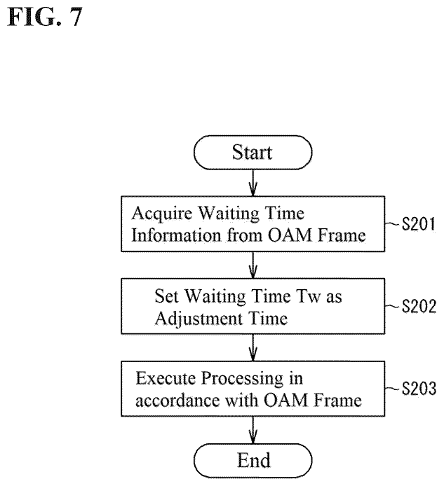

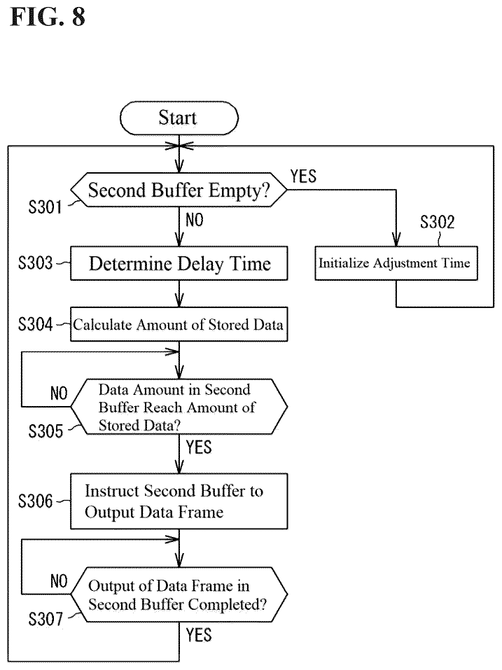

Control unit 170 of transmission apparatus 100 functioning as the receiving apparatus executes the following OAM frame processing and buffer control processing. FIG. 7 is a flowchart illustrating an example of OAM frame processing of control unit 170 in transmission apparatus 100 functioning as the receiving apparatus according to the embodiment, and FIG. 8 is a flowchart illustrating an example of buffer control processing.

An example of the OAM frame processing will be described with reference to FIG. 7. When demultiplexer 150B of transmission apparatus 100B accepts the OAM frame, a request-to-interrupt is generated, and when control unit 170 receives the request-to-interrupt, the OAM frame processing is executed.

When control unit 170 accepts the OAM frame, control unit 170 acquires the waiting time information from the specific area of the OAM frame (step S201). Control unit 170 sets waiting time T_{W} indicated in the waiting time information as the adjustment time for jitter-adjustment (step S202). The set adjustment time is stored in a storage area provided in control unit 170.

Control unit 170 executes processing for management of transmission system 10 in accordance with the OAM frame (step S203). The OAM frame processing is thus completed.

An example of the buffer control processing will be described with reference to FIG. 8. Control unit 170 can refer to the state of second buffer 160 (a state of holding data or a state of not holding data (empty)). Control unit 170 determines whether or not second buffer 160 is empty (step S301).

When second buffer 160 is empty (YES in step S301), control unit 170 initializes the adjustment time (step S302), and returns to step S301. The initial value of the adjustment time is zero. When the above-described OAM frame processing is activated after the adjustment time is initialized, the adjustment time is updated in the OAM frame processing.

The gap between frames is adjusted by controlling the amount of data temporarily held in second buffer 160. That is, when a period from the start of input of the data frame to second buffer 160 to the start of output of the data frame from second buffer 160 (hereinafter referred to as “delay period”) is determined, control unit 170 calculates a data amount corresponding to the delay time (hereinafter referred to as “stored data amount”), waits until the stored data amount of data is stored in second buffer 160, and starts the output of the data frame at the time when the stored data amount of data is stored in second buffer 160. When second buffer 160 is not empty (holding data) (NO in step S301), control unit 170 determines the delay time (step S303) and calculates the amount of the stored data (step S304).

The delay time is calculated as, for example, a difference between a standard delay time and the adjustment time. The standard delay time is a delay time in a case where transmission apparatus 100 which is the receiving apparatus transmits the data frames to client device 200 without changing the gap between the data frames received from transmission apparatus 100 which is the transmitting apparatus. In order to ensure a margin for jitter adjustment, the standard delay time is set to a predetermined value so that the delay time is equal to or greater than zero even when the adjustment time is subtracted from the standard delay time. The amount of the stored data is calculated from the data transmission rate of second communication I/F 140 and the delay time.

Control unit 170 determines whether or not the amount of data stored in second buffer 160 reaches the amount of the stored data (step S305). When the amount of the data stored in second buffer 160 has not reached the amount of the stored data (NO in step S305), control unit 170 executes step S305 again.

When the amount of data stored in second buffer 160 reaches the amount of the stored data (YES in step S305), control unit 170 instructs second buffer 160 to output data (step S306). Thus, in second buffer 160, the output of the next data frame is started after the delay time elapses from the output of the previous data frame is completed. Control unit 170 checks the state of second buffer 160 and determines whether or not the output of the data frame is completed (step S307). When the output of the data frame in second buffer 160 is not completed (NO in step S307), control unit 170 executes step S307 again. When the output of the data frame in second buffer 160 is completed (YES in step S307), control unit 170 returns to step S301.

An example of transmitting/receiving of a frame in transmission apparatus 100B which is a receiving apparatus will be described with reference to FIG. 6. Control unit 170B executes the above-described OAM frame processing and buffer control processing, and thereby transmission apparatus 100B operates as follows. Second communication I/F 140B of transmission apparatus 100B starts the reception of the first frame transmitted from transmission apparatus 100A, and the input of the received first frame to second buffer 160B is started.

The reception of the first frame by second communication I/F 140B is completed, and the input of the received first frame to second buffer 160B is completed.

Control unit 170B controls second buffer 160B to start outputting the first frame. The output portion of the first frame is input to first communication I/F 110B, and the transmission of the first frame to client device 200B is started.

OAM frame 700 reaches at transmission apparatus 100B after at least inter-frame gap T_{FG} elapses from the completion of reception of the first frame by transmission apparatus 100B. Second communication I/F 140B starts receiving OAM frame 700 transmitted from transmission apparatus 100A, and completes the reception of OAM frame 700. Second communication I/F 140B outputs the received OAM frame 700 to control unit 170B. Control unit 170B acquires waiting time information 710 from the Vendor Specific Information of the Local/Remote Information TLV of OAM frame 700 and stores the waiting time information. Further, control unit 170B executes processing for management of transmission system 10 in accordance with OAM frame 700.

After inter-frame gap T_{FG} elapses from the completion of reception of OAM frame 700 by transmission apparatus 100B, the second frame reaches at transmission apparatus 100B. Second communication I/F 140B starts the reception of the second frame transmitted from transmission apparatus 100A and starts the input of the received second frame to second buffer 160B.

Second buffer 160B outputs the first frame by FIFO. The output of the first frame from second buffer 160B is completed, and the transmission of the first frame from first communication I/F 110B to client device 200B is completed.

Control unit 170B calculates a delay time T_{D} using the stored waiting time information 710. That is, control unit 170B determines the difference between a standard delay time D_{STD} and an adjustment time T_{AD}(=waiting time T_{W}) as delay time T_{D}. Control unit 170B instructs second buffer 160B to start the output of the second frame at the time when the amount of data of the second frame stored in second buffer 160B reaches the amount of the stored data corresponding to delay time T_{D} (when the amount of data of the second frame stored in second buffer 160B has already reached the amount of the stored data, at that time).

A frame interval T′_{G2} adjusted as described above is a time shorter than the data reception interval T_{G2} which is a time from the completion of reception of the first frame by transmission apparatus 100B to the start of reception of the second frame. In a specific example, frame interval T′_{G2} is a time acquired by subtracting waiting time T_{W} from data reception interval T_{G2}.

As shown in FIG. 6, data reception interval T_{G2} is equal to the time from the timing at which the output of the first frame from first buffer 120A of transmission apparatus 100A is completed to the timing at which the output of the second frame is started. More specifically, data reception interval T_{G2} is equal to the sum of waiting time T_{W} and time T_{G1} from the timing at which the output of the first frame from first buffer 120A is completed to the scheduled output start timing. Thus, frame interval T′_{G2} is equal to time T_{G1} from the completion of the reception of the first frame to the start of the reception of the second frame in transmission apparatus 100A. Thus, by setting the output start timing of the second frame from second buffer 160B to the timing after frame interval T′_{G2} elapses from the completion of output timing of the first frame, the delay in the transmission of the second frame is reduced, and the occurrence of the frame jitter can be prevented.

Second communication I/F 140B continues to input the received second frame to second buffer 160B until the reception of the second frame is completed. The reception of the second frame by second communication I/F 140B is completed, and the input of the second frame to second buffer 160B is completed.

Second buffer 160B outputs the second frame by the FIFO. The output of the second frame from second buffer 160B is completed, and the transmission of the second frame from first communication I/F 110B to client device 200B is completed.

### 4. First Modification

In the above-described embodiment, the waiting time information is stored in the specific area of OAM frame 700, but the present disclosure is not limited thereto. The waiting time information may be stored in a notification frame that is a frame different from OAM frame 700, and the notification frame may be transmitted separately from the OAM frame in the relay section. Demultiplexer 150 of transmission apparatus 100 functioning as the receiving apparatus can identify the notification frame in addition to the OAM frame. In one example, demultiplexer 150 identifies the frame following the OAM frame as a notification frame. More specifically, demultiplexer 150 can identify a frame in which a MAC address of a transmission source field included in the frame is the MAC address of the transmission apparatus or a MAC address of a destination field is the MAC address of the reception apparatus, and received after the OAM frame, as the notification frame. In another example, the size of the notification frame may be determined in advance, and demultiplexer 150 may identify a frame that has the relevant size and that is received after the OAM frame as the notification frame. As another example, a network configured by a transmitting apparatus and a receiving apparatus may be set as a virtual LAN, a VLAN ID allocated to the virtual LAN may be included in the notification frame, and demultiplexer 150 may identify a frame including the VLAN ID and received after an OAM frame as the notification frame.

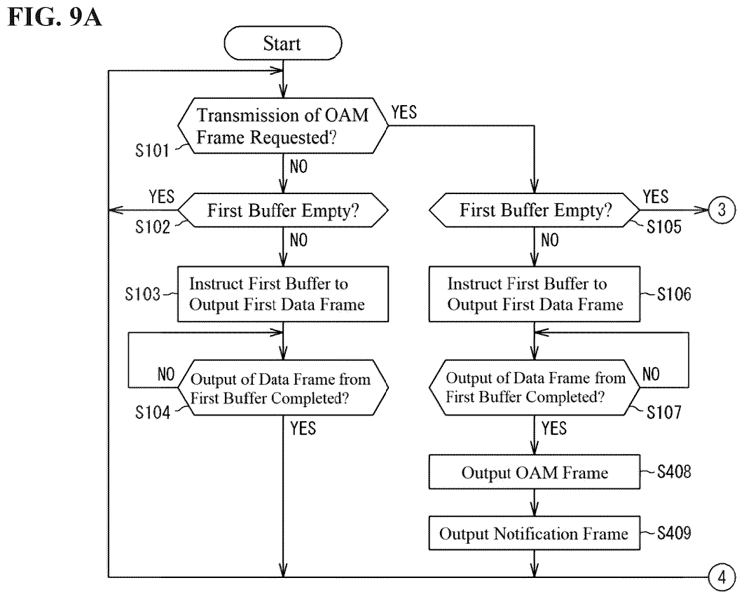

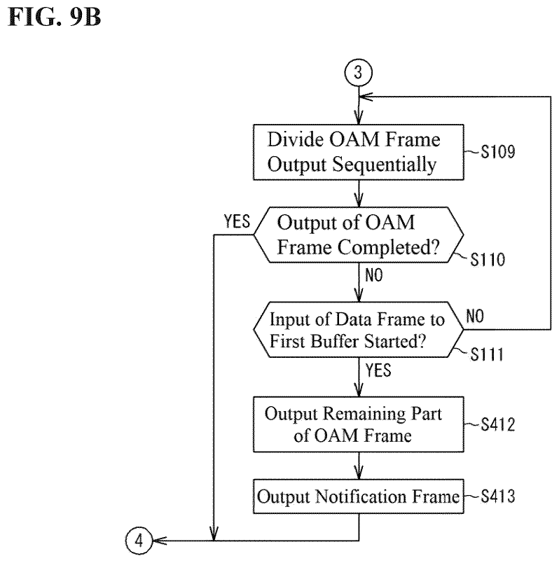

FIG. 9A and FIG. 9B are flowcharts illustrating an example of processing of control unit 170 in transmission apparatus 100 functioning as the transmitting apparatus according to the first modification. Steps S101 to S107 are the same as those described in the above embodiment, and thus the description thereof will be omitted.

When the output of the data frame from first buffer 120 is completed (YES in step S107), control unit 170 outputs the OAM frame after inter-frame gap T_{FG} elapses from the timing of the completion of output (step S408). The waiting time information is not stored in the OAM frame output in step S408. When the output of the OAM frame is completed, control unit 170 creates the notification frame in which the waiting time information is stored, and outputs the created notification frame (step S409). When the output of the notification frame is completed, control unit 170 returns to step S101.

Steps S109 to S111 are the same as those described in the above embodiment, and thus the description thereof will be omitted.

When the input of the data frame to first buffer 120 starts (YES in step S111), control unit 170 outputs the remaining part of the OAM frame (step S412). Control unit 170 calculates waiting time T_{W}, creates the notification frame in which the waiting time information is stored, and outputs the created notification frame (step S413). When the output of the notification frame is completed, control unit 170 returns to step S101.

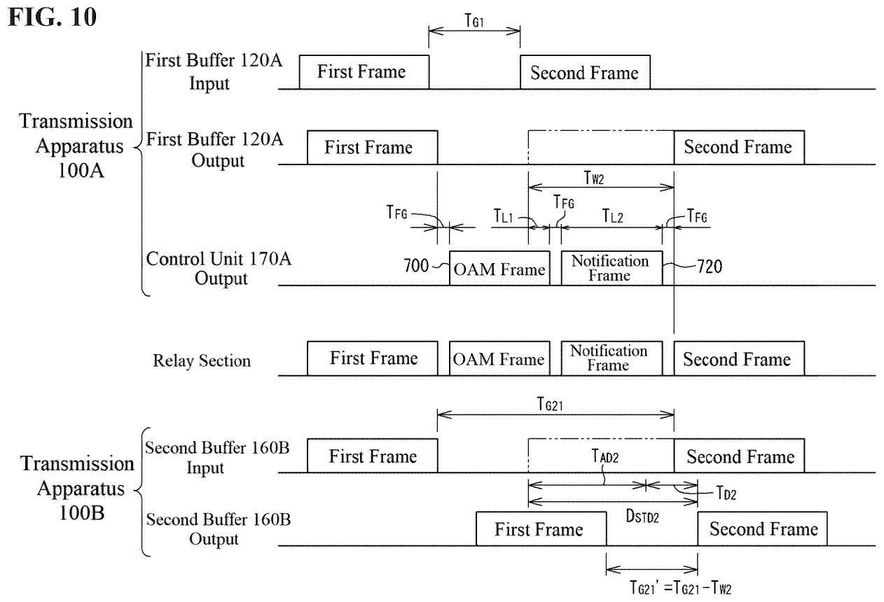

FIG. 10 is a timing chart for explaining input/output timing of a frame in the first modification of the transmission system according to the embodiment.

At a timing when inter-frame gap T_{FG} elapses from the completion of the output of the first frame from first buffer 120A, control unit 170A starts the output of OAM frame 700. In the example of FIG. 10, the input of the second frame to first buffer 120A is started during the output of OAM frame 700. Further, control unit 170A starts the output of a notification frame 720 at a timing when inter-frame gap T_{FG} elapses from the output of OAM frame 700 is completed. At the timing when inter-frame gap T_{FG} elapses from the completion of the output of notification frame 720, control unit 170A causes first buffer 120A to start the output of the second frame.

The time from the scheduled output start timing to the timing at which the output of OAM frame 700 from control unit 170A is completed is referred to as T_{L1}, and the time from the start of the output of the notification frame from control unit 170A to the completion of the output is referred to as T_{L2}. Control unit 170A waits for the start of the output of the second frame from first buffer 120A until the output of OAM frame 700 and notification frame 720 from control unit 170A is completed. Control unit 170A causes first buffer 120A to start the output of the second frame after a waiting time T_{W2} elapses from the scheduled output timing. Waiting time T_{W2} is equal to the sum of a time T_{L1}, inter-frame gap T_{FG}, a time T_{L2}, and inter-frame gap T_{FG}. Notification frame 720 stores waiting time information indicating waiting time T_{W2}.

In the relay section, the first frame, OAM frame 700, notification frame 720, and the second frame are transmitted in order.

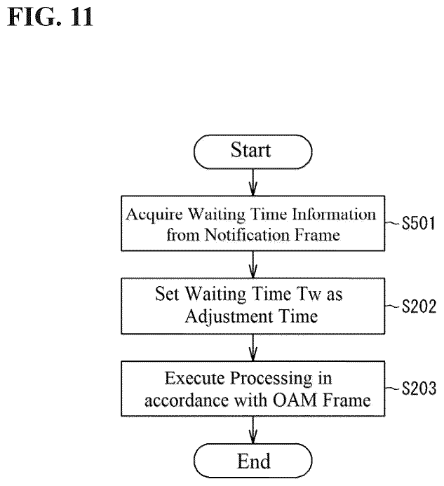

Control unit 170 of transmission apparatus 100 functioning as the receiving apparatus executes the OAM frame processing and the buffer control processing. FIG. 11 is a flowchart illustrating an example of OAM frame processing of control unit 170 in transmission apparatus 100 functioning as the receiving apparatus according to the first modification.

An example of the OAM frame processing will be described with reference to FIG. 11. When transmission apparatus 100 receives the OAM frame, a request-to-interrupt is generated, and when control unit 170 accepts the request-to-interrupt, the OAM frame processing is executed.

When control unit 170 accepts the OAM frame and the notification frame, control unit 170 acquires the waiting time information from the notification frame (step S501). Steps S202 to S203 are the same as those described in the above embodiment, and thus the description thereof will be omitted. The buffer control processing executed by control unit 170 is the same as that described in the above embodiment, and thus the description thereof will be omitted.

Returning to FIG. 10, an example of transmitting/receiving of a frame in transmission apparatus 100B as the receiving apparatus will be described. Second communication I/F 140B of transmission apparatus 100B inputs the received first frame to second buffer 160B, inputs the received OAM frame 700 and notification frame 720 to control unit 170B, and inputs the received second frame to second buffer 160B.

Control unit 170B acquires the waiting time information from notification frame 720, and calculates delay time T_{D2} using the waiting time information. That is, control unit 170B determines the difference between a standard delay time D_{STD2} and an adjustment time T_{AD2}(=waiting time T_{W2}) as delay time T_{D2}. Control unit 170B instructs second buffer 160B to start the output of the second frame at the time when the amount of data of the second frame stored in second buffer 160B reaches the amount of the stored data corresponding to delay time T_{D2}.

Frame interval T′_{G21} adjusted as described above is a time shorter than a data reception interval T_{G21} which is a time from the completion of reception of the first frame by transmission apparatus 100B to the start of reception of the second frame. In a specific example, frame interval T′_{G21} is a time obtained by subtracting waiting time T_{W2} from data reception interval T_{G21}.

Data reception interval T_{G21} is equal to the time from the timing at which the output of the first frame from first buffer 120A of transmission apparatus 100A is completed to the timing at which the output of the second frame is started. More specifically, data reception interval T_{G21} is equal to the sum of waiting time T_{W2} and time T_{G1} from the timing at which the outputting of the first frame from first buffer 120A is completed to the scheduled output start timing. Thus, frame interval T′_{G21} is equal to time T_{G1} from the completion of the reception of the first frame to the start of the reception of the second frame in transmission apparatus 100A. Thus, by setting the output start timing of the second frame from second buffer 160B to the timing after frame interval T′_{G21} elapses from the completion timing of outputting of the first frame, the delay in the transmission of the second frame is reduced, and the occurrence of frame jitters can be prevented.

### 5. Second Modification

In the above-described embodiment, transmission apparatus 100 inserts the OAM frame between frames in units of one frame, but the present disclosure is not limited thereto. Transmission apparatus 100 may insert the OAM frame between frame groups each including one or more frames.

When the transmission rate is 100 Gbps or higher, the internal clock frequencies of the circuits of transmission apparatus 100 are lower than the transmission rate, and thus, a segment type interface in which a segment of a preset data amount is used as a processing unit is adopted.

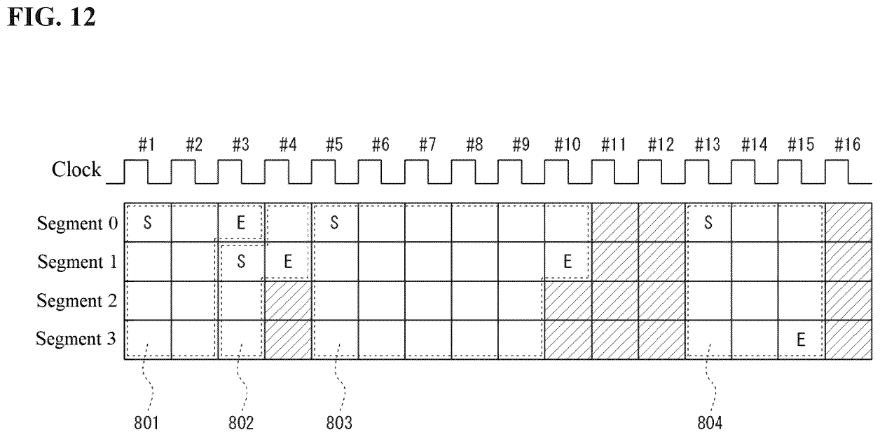

FIG. 12 is a diagram illustrating a relationship between a frame boundary and a clock cycle in the second modification of the transmission apparatus according to the embodiment. FIG. 12 shows an example in which the transmission rate is 100 Gbps and the internal clock rate is 300 MHz. In this example, each frame is divided into 128 bit segments, and four segments of 0 to 3 are processed per a clock cycle. The rectangular wave in the figure indicates a clock waveform.

In the figure, “S” indicates the first segment of the frame, and “E” indicates the last segment of the frame. A frame 801 is data from segment 0 of clock #1 to segment 0 of clock #3. A frame 802 is data from segment 1 of clock #3 to segment 1 of clock #4. A frame 803 is data from segment 0 of clock #5 to segment 1 of clock #10. A frame 804 is data from the segment 0 of clock #13 to segment 3 of clock #15.

The last segment of frame 801 and the first segment of frame 802 are both assigned to clock #3. Thus, the transmission apparatus cannot process frames 801 and 802 separately.

In this modification, when adjacent frames are separated by one clock or more, transmission apparatus 100 divides the frame group with the gap between the frames as a boundary. For example, in the example of FIG. 12, there is no gap of one segment or more between frames 801 and 802. Thus, frames 801 and 802 are included in the same frame group. Although a gap of two segments exists between frames 802 and 803, the gap is not equal to or more than one clock. Thus, frame 803 is also included in the same frame group as frames 801 and 802. Frames 803 and 804 are separated by two clocks #11 and #12. Thus, frame 803 and frame 804 are allocated to different frame groups. That is, frame 804 is included in a frame group different from the frame group of frames 801, 802 and 803. Hereinafter, the frame group of frames 801, 802 and 803 is referred to as a “first frame group”, and the frame group of frame 804 is referred to as a “second frame group”.

In this modification, transmission apparatus 100 functioning as the transmitting apparatus can insert the OAM frame between the first frame group and the second frame group. That is, after the output of the first frame group from first buffer 120 is completed, control unit 170 starts the output of the OAM frame, and the start of the output of the second frame group from first buffer 120 can be waited until the output of the OAM frame is completed. On the other hand, transmission apparatus 100 cannot insert the OAM frame between frames 801 and 802. Similarly, transmission apparatus 100 cannot insert the OAM frame between frames 802 and 803. Transmission apparatus 100 can store the waiting time information in the specific area of the OAM frame or store the waiting time information in the notification frame different from the OAM frame, and transmit the OAM frame or the notification frame in which the waiting time information is stored to the corresponding transmission apparatus.

Transmission apparatus 100 functioning as the receiving apparatus determines the output start timing at which the output of the second frame group from the second buffer is started based on the waiting time information, and causes second buffer 160 to start the output of the second frame group at the determined output start timing. Thus, the delay in transmission of the second frame group is reduced, and the occurrence of frame jitters can be prevented.

### 6. Appendix

### Appendix 1

A data transmitting method for transmitting data from a transmitting apparatus to a receiving apparatus in a transmission system including the transmitting apparatus and the receiving apparatus, the data transmitting method including:
inputting first client data received from a first client device to a first buffer included in the transmitting apparatus, and after transmitting the first client data output from the first buffer to the receiving apparatus, transmitting a management frame and waiting time information, the management frame being used for management of the transmission system; and
waiting for second client data to be output from the first buffer until transmission of the management frame and the waiting time information is completed, causing the first buffer to output the second client data after the transmission of the management frame and the waiting time information is completed, and transmitting the second client data output from the first buffer to the receiving apparatus, wherein
the waiting time information is information based on a waiting time, the waiting time being a time of waiting for the second client data to be output from the first buffer.

### Appendix 2

A data receiving method for receiving, by a receiving apparatus, data transmitted from a transmitting apparatus in a transmission system including the transmitting apparatus and the receiving apparatus, the data receiving method including:
after receiving first client data transmitted from the transmitting apparatus, receiving a management frame and waiting time information transmitted from the transmitting apparatus, the management frame being used for management of a transmission system including the transmitting apparatus and the receiving apparatus, further receiving second client data transmitted from the transmitting apparatus after receiving the management frame and the waiting time information, and inputting the received second client data to a second buffer included in the receiving apparatus; and
determining an output start timing at which output of the second client data from the second buffer starts, based on the waiting time information, causing the second buffer to start the output of the second client data at the determined output start timing, and transmitting the second client data output from the second buffer to a second client device, wherein
the waiting time information is information based on a waiting time, the waiting time being a time of waiting for the second client data to be output from a first buffer included in the transmitting apparatus to transmit the management frame and the waiting time information from the transmitting apparatus, and
the output start timing is a timing at which a time shorter than a data reception interval elapses from completion of output of the first client data from the second buffer, the data reception interval being a time from completion of reception of the first client data to start of reception of the second client data.

### 7. Supplements

The embodiments disclosed herein are illustrative and non-restrictive in all respects. The scope of the present invention is defined by the appended claims rather than the foregoing embodiments, and includes all modifications within the scope and meaning equivalent to the appended claims.

### REFERENCE SIGNS LIST

10 transmission system
100, 100A, 100B transmission apparatus
110, 110A, 110B first communication interface (first communication I/F)
120, 120A, 120B first buffer
130, 130A, 130B multiplexer (MUX)
140, 140A, 140B second communication interface (second communication I/F)
150, 150A, 150B demultiplexer (DEMUX)
160, 160A, 160B second buffer
170, 170A, 170B control unit
200, 200A, 200B client device
300, 300A, 300B optical fiber cable
400 optical fiber cable
500, 500A, 500B optical transceiver
600, 600A, 600B optical transceiver
700 OAM frame (management frame)
710 waiting time information
720 notification frame
801, 802, 803, 804 frame

1. A transmission system comprising:
a transmitting apparatus configured to receive client data transmitted from a first client device and transmit the received client data; and
a receiving apparatus configured to receive the client data transmitted from the transmitting apparatus and transmit the received client data to a second client device, wherein
the transmitting apparatus includes:
a first buffer configured to store the client data transmitted from the first client device; and
a first control circuit configured to control a timing of outputting the client data from the first buffer to transmit the client data to the receiving apparatus,
the receiving apparatus includes:
a second buffer configured to store the client data transmitted from the transmitting apparatus; and
a second control circuit configured to control a timing of outputting the client data from the second buffer to transmit the client data to the second client device,
the transmitting apparatus is configured to, after transmitting first client data output from the first buffer to the receiving apparatus, transmit a management frame and waiting time information, the management frame being used for management of the transmission system,
the first control circuit is configured to wait for second client data to be output from the first buffer until the transmitting apparatus completes transmission of the management frame and the waiting time information, and cause the first buffer to output the second client data after the transmitting apparatus completes transmission of the management frame and the waiting time information,
the waiting time information is information based on a waiting time, the waiting time being a time of waiting for the second client data to be output from the first buffer,
the second control circuit is configured to determine an output start timing at which output of the second client data from the second buffer starts, based on the waiting time information, and cause the second buffer to start the output of the second client data at the determined output start timing, and
the output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus.

2. The transmission system according to claim 1, wherein
the output start timing is a timing at which a time obtained by subtracting the waiting time from the data reception interval elapses from completion of output of the first client data from the second buffer.

3. The transmission system according to claim 1, wherein
the first control circuit is configured to calculate, as the waiting time, a sum of a time from start of input of the second client data to the first buffer to completion of transmission of the management frame and the waiting time information and a preset time interval between frames and the waiting time information.

4. The transmission system according to claim 1, wherein
the waiting time information is stored in a specific area of the management frame.

5. The transmission system according to claim 4, wherein
the management frame is an OAM frame, and
the waiting time information is stored in a Local/Remote Information TLV of the OAM frame.

6. The transmission system according to claim 1, wherein
the waiting time information is stored in a notification frame, the notification frame being a frame different from the management frame.

7. The transmission system according to claim 1, wherein
the client data is a frame.

8. The transmission system according to claim 1, wherein
the client data is a frame group including a plurality of frames.

9. A transmitting apparatus for receiving client data transmitted from a client device and transmitting the received client data to a receiving apparatus, the transmitting apparatus comprising:
a buffer configured to store the client data transmitted from the client device; and
a control circuit configured to control a timing of outputting the client data from the buffer to transmit the client data to the receiving apparatus, wherein
the transmitting apparatus is configured to, after transmitting first client data output from the buffer to the receiving apparatus, transmit a management frame and waiting time information, the management frame being used for management of a transmission system including the transmitting apparatus and the receiving apparatus,
the control circuit is configured to wait for second client data to be output from the buffer until the transmitting apparatus completes transmission of the management frame and the waiting time information, and cause the buffer to output the second client data after the transmitting apparatus completes transmission of the management frame and the waiting time information, and
the waiting time information is information based on a waiting time, the waiting time being a time of waiting for the second client data to be output from the buffer.

10. A receiving apparatus for receiving client data transmitted from a transmitting apparatus and transmitting the received client data to a client device, the receiving apparatus comprising:
a second buffer configured to store the client data transmitted from the transmitting apparatus; and
a control circuit configured to control a timing of outputting the client data from the second buffer to transmit the client data to the client device, wherein
the receiving apparatus is configured to, after receiving first client data transmitted from the transmitting apparatus, receive a management frame and waiting time information transmitted from the transmitting apparatus, the management frame being used for management of a transmission system including the transmitting apparatus and the receiving apparatus, and further receive second client data transmitted from the transmitting apparatus after receiving the management frame and the waiting time information,
the waiting time information is information based on a waiting time, the waiting time being a time of waiting for the second client data to be output from a first buffer included in the transmitting apparatus to transmit the management frame and the waiting time information from the transmitting apparatus,
the control circuit is configured to determine an output start timing at which output of the second client data from the second buffer starts, based on the waiting time information, and cause the second buffer to start the output of the second client data at the determined output start timing, and
the output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus.

11. A data transmission method in a transmission system including a transmitting apparatus and a receiving apparatus, the data transmission method comprising:
by the transmitting apparatus, inputting first client data received from a first client device to a first buffer, and after transmitting the first client data output from the first buffer to the receiving apparatus, transmitting a management frame and waiting time information, the management frame being used for management of the transmission system;
by the transmitting apparatus, waiting for second client data to be output from the first buffer until the transmitting apparatus completes transmission of the management frame and the waiting time information, causing the first buffer to output the second client data after the transmitting apparatus completes transmission of the management frame and the waiting time information, and transmitting the second client data output from the first buffer to the receiving apparatus;
by the receiving apparatus, receiving the management frame, the waiting time information, and the second client data transmitted from the transmitting apparatus, and inputting the received second client data to a second buffer; and
by the receiving apparatus, determining an output start timing at which output of the second client data from the second buffer starts, based on the waiting time information, causing the second buffer to start an output of the second client data at the determined output start timing, and transmitting the second client data output from the second buffer to a second client device, wherein
the waiting time information is information based on a waiting time, the waiting time being a time of waiting for the second client data to be output from the first buffer, and
the output start timing is a timing at which a time shorter than a data reception interval elapses from completion of output of the first client data from the second buffer, the data reception interval being a time from completion of reception of the first client data by the receiving apparatus to start of reception of the second client data by the receiving apparatus.

12. The transmission system according to claim 2, wherein
the first control circuit is configured to calculate, as the waiting time, a sum of a time from start of input of the second client data to the first buffer to completion of transmission of the management frame and the waiting time information and a preset time interval between frames and the waiting time information.

13. The transmission system according to claim 2, wherein
the waiting time information is stored in a specific area of the management frame.

14. The transmission system according to claim 3, wherein
the waiting time information is stored in a specific area of the management frame.

15. The transmission system according to claim 2, wherein
the waiting time information is stored in a notification frame, the notification frame being a frame different from the management frame.

16. The transmission system according to claim 3, wherein
the waiting time information is stored in a notification frame, the notification frame being a frame different from the management frame.

17. The transmission system according to claim 2, wherein
the client data is a frame.

18. The transmission system according to claim 3, wherein
the client data is a frame.

19. The transmission system according to claim 4, wherein
the client data is a frame.

20. The transmission system according to claim 5, wherein
the client data is a frame.
